(19) United States
(12) Patent Application Publication
(10) Pub. No.: US 2007/0065622 A1
(43) Pub. Date: Mar. 22, 2007

(54) Safety Mat Active Joining Trim

(75) Inventors: Louis L. Schubert, San Jose, CA (US); Boris Shteynberg, San Francisco, CA (US); Vladimir Belfor, San Francisco, CA (US)

Correspondence Address: COATS & BENNETT, PLLC, P O BOX 5, RALEIGH, NC, 27602, US

(73) Assignee: SCIENTIFIC TECHNOLOGIES INCORPORATED, Fremont, CA (US)

(21) Appl. No.: 11/533,156

(22) Filed: Sep. 19, 2006

Related U.S. Application Data
(60) Provisional application No. 60/719,623, filed on Sep. 22, 2005.

(51) Int. Cl. B32B 3/00

(52) U.S. Cl. 428/61; 428/119; 428/58

(57) ABSTRACT

An active joining trim assembly allows the assembly's cover member to float on the abutting edge regions of adjacent safety mats. With this configuration, the joining trim assembly functions as an “active,” weight-responsive area. In at least one embodiment, the active joining trim assembly comprises a base member, a cover member, and one or more retaining members that clip or otherwise snap the base and cover members together. For example, in one embodiment, the underside of the cover member includes a clip retaining feature, the base member includes a central channel, and the retaining member(s) fasten or otherwise anchor to the clip retaining feature and flexibly clip onto the central channel in sliding, vertical engagement. Equivalently, the retaining member(s) anchor to the base member and flexibly clip onto the clip retaining feature of the cover member.

### RELATED APPLICATIONS

This application claims priority under 35 U.S.C. § 119(e) to U.S. Provisional Application Ser. No. 60/719,623, filed on 22 Sep. 2005 and which is incorporated herein by reference.

### BACKGROUND

1. Field of the Invention

The present invention generally relates to safety mats, and particularly relates to an “active” safety mat joining trim assembly.

2. Background Information

Safety mats represent a well-known type of safety device. While their design and construction details vary across intended applications and across manufacturers, safety mats in general operate as pressure sensitive switches that open (or close) one or more electrical connections responsive to weight. As one example, a mat positioned at a work piece loading area of a potentially hazardous machine may be configured to open the electrical supply line of the machine and thereby prevent operation of the machine while the operator or anyone else stands on the mat. Conversely, a safety mat positioned at the operating panel of a machine may be configured to close an electrical supply line of the machine and thereby prevent operation of the machine unless the operator stands on the mat

Although some manufacturers offer custom mat sizes and shapes, many manufacturers offer safety mats in a number of standard rectangular sizes. With the ready availability of standard mat sizes, users cover larger and irregularly shaped areas using combinations of smaller safety mats. Multi-mat installations of this type generally rely on the use of “joining trim” between adjacent mats. The joining trim, which may anchor to the floor via screws, maintains the relative position of abutting mats, and maintains the overall arrangement of mats at their desired placements on the floor.

While multi-mat arrangements provide advantages in terms of large and/or irregular area coverage, the use of conventional joining trim imposes several disadvantages. For example, the joining trim itself may represent a “dead” sensing area, i.e., weight exerted on the trim does not actuate the adjoining safety mats. Further, the joining trim may complicate routing of safety mat cables, i.e., placing safety mats into abutting proximity complicates the routing of the electrical cables coupling each safety mat's switch contacts to corresponding external connections.

### SUMMARY

In one embodiment of actively joining adjacent safety mats as taught herein, a joining trim assembly comprises a base member configured to underlie a mat seam formed by abutting mat edges of adjacent safety mats, a cover member configured to overlay the mat seam; and one or more retaining members configured to couple the cover and base members together. More particularly, the retaining member(s) couple the cover and base members together, while allowing the cover member to float on the abutting mat edges and thereby transfer a downward force applied to the cover member to one or both of the adjacent safety mats. “Floating” the cover member in this manner allows for vertical travel of the cover member responsive to downward force, i.e., the cover member depresses downward toward the base member under force, such as when stepped on or run over, thereby actuating one or both of the adjacent safety mats.

In one or more embodiments of the above-described joining trim assembly, the base member includes a central channel, which may form a cable raceway for routing safety mat cables. Whether or not a cable raceway is provided, the retaining member(s) are, in one embodiment, designed to fasten or otherwise anchor to a clip retaining feature on the underside of the cover member, and flexibly clip to the central channel of the base member. For example, the retaining member(s) comprise, in at least one embodiment, flexible spring clips that engage with the underside of the cover member and removably clip to the central channel of the base member. Equivalently, the retaining member(s) fasten to or otherwise engage the base member and flexibly clip to the cover member.

In another embodiment, an apparatus for actively joining adjacent safety mats comprises base and cover members, along with one or more retaining members. The elongate base member comprises upwards facing base areas on either side of a central channel running along a length of the base member. Each base area is configured to underlie an abutting edge region of a respective one of the adjacent safety mats. Similarly, the elongate cover member comprises downwards facing cover areas on either side of a central clip retaining feature running along a length of the cover member. Each cover area is configured to overlay the abutting edge region of a respective one of the adjacent safety mats.

In this context, the one or more retaining members are configured to flexibly clip the cover and base members together in a manner that allows the cover member to float on the abutting edge regions of the adjacent safety mats. By floating the cover member in this manner, downward force on the cover member transfers to one or both of the adjacent safety mats. Thus, stepping on, or otherwise pressing on the cover member, depresses the cover member downward and thereby actuates one or both of the adjacent safety mats.

Note, too, that the flexibility of the retaining member(s) in at least some embodiments, allows the cover member to tilt side to side, in response to the application of off-center downward force to the cover member, which provides for reliable safety mat actuation irrespective of whether downward force is applied uniformly or non-uniformly to the cover member. In at least one embodiment, the retaining members comprise plastic retaining members having a base portion that anchors to one of the cover or base members, and a spring clip portion that clips to the other one of the cover or base members. The retaining members may be extruded, molded, or machined, as may the cover and base members. In at least one embodiment, at least the cover and base members comprise extruded plastic, metal, or composite pieces that are formed or cut to desired lengths. Extrusion process offers significant manufacturing advantages with regard to forming the clip retaining feature of the cover member, and the central channel feature of the base member.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a diagram of one embodiment of an active joining trim assembly, shown in cross-section along with adjoining safety mats for context.

FIG. 2 is a diagram of the active joining trim assembly of FIG. 1, shown as an end-view and without the adjoining safety mats for clarity.

FIG. 3 is a diagram illustrating “View A” details from the joining trim assembly of FIG. 1.

FIGS. 4 and 5 are diagrams illustrating bottom and top perspective views of one embodiment of a retaining member as may be used in the joining trim assembly of FIG. 1.

FIGS. 6 and 7 are diagrams illustrating a bottom perspective view of one embodiment of a joining trim assembly cover member, along with corresponding retaining members.

FIGS. 8 through 15 are diagrams illustrating additional embodiments of an active joining trim assembly shown in cross-section along with adjoining safety mats for context.

### DETAILED DESCRIPTION OF THE INVENTION

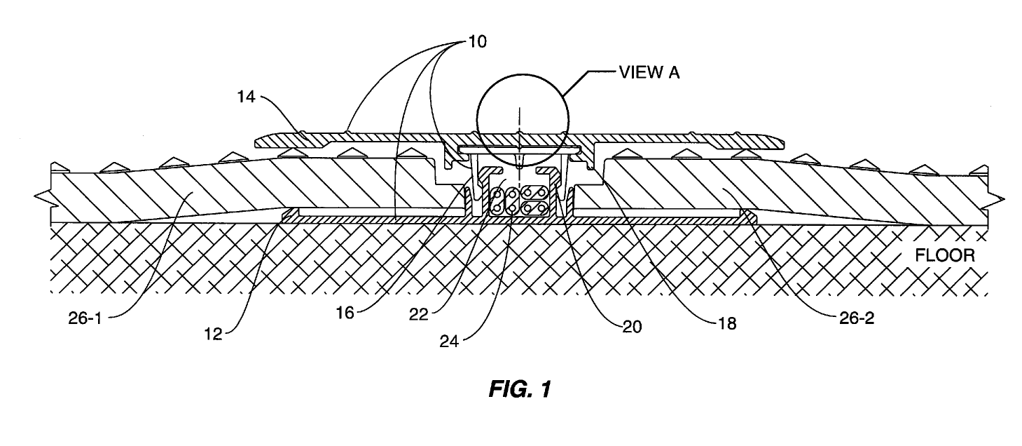

FIG. 1 illustrates one embodiment of an active joining trim assembly 10 according to one embodiment taught herein. The active joining trim assembly 10, referred to hereinafter for convenience simply as “trim assembly 10,” comprises a base member 12, a cover member 14, and one or more retaining members 16.

In more detail, the underside of the cover member 14 includes a central clip retaining feature 18 that retains the one or more retaining members 16, which may be configured as flexible clips made from plastic or another resilient material. With this configuration, the retaining member(s) 16 are fastened or otherwise anchored to the underside of the cover member 14, and allow the cover member 14 to be removably clipped or otherwise coupled to a central channel 20 of the base member 12. In general, the central channel 20 comprises one or more walls or other vertically-projecting features onto which the retaining member(s) may be clipped or otherwise attached. In at least one embodiment, the central channel 20 defines a cable raceway area 22 that is suitable for routing one or more safety mat cables 24, which provides a convenient mechanism for routing safety mat cables between the abutting edges of the adjacent safety mats 26-1 and 26-2.

The trim assembly 10 illustrated in FIG. 1, and other trim assembly embodiments taught herein, allow the cover member 14 to “float” on the topside abutting edge regions of the adjacent safety mats 26-1 and 26-2, meaning that downward force applied to the trim assembly 10 transfers to one or both of the safety mats 26-1 and 26-2. Indeed, with the retaining members 16 implemented as flexible clips or the like, the cover member 14 not only moves downward with applied weight, it also tilts from side to side with the application of off-center weight. As such, whether the trim assembly 10 is stepped on or run over fully or only partially, it depresses downward into one or both of the adjacent safety mats 26-1 and 26-2. Thus, the trim assembly 10 “actively” joins the two safety mats 26-1 and 26-2 by acting as an active weight-sensing joining strip placed in the mat seam formed between the abutting mat edges.

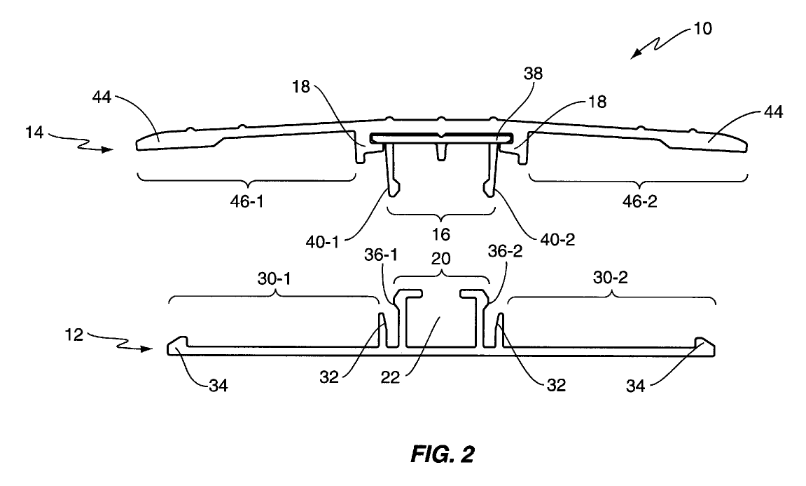

To appreciate this functionality, FIG. 2 depicts the trim assembly embodiment of FIG. 1 in more detail, with the illustration separating the base and cover members 12 and 14 and omitting the safety mats 26-1 and 26-2 for clarity. One sees that the illustrated embodiment of the base member 12 comprises a central channel 20, with base areas 30-1 and 30-2 running along either side of the central channel 20. The base areas underlie the bottom-side edge regions of the adjacent safety mats being joined by the trim assembly 10.

In at least one embodiment, vertical projections 32 and 34 bound the base areas 30-1 and 30-2, and may aid in supporting and aligning the adjacent safety mats joined by the trim assembly 10. One also sees that vertical walls of the central channel 20 may be extruded or otherwise formed with extending features 36-1 and 36-2, to facilitate retention of the retaining member(s) 16, such as when the retaining member(s) 16 are configured as spring clips.

Continuing with details from FIG. 2, one sees that the illustrated embodiment of the cover member 14 includes the previously illustrated central clip retaining feature 18, which may be extruded or otherwise formed to have one or more slots, grooves, insets, or the like, which allow anchoring of the retaining members 16 to the underside of cover member 12. For example, in at least one embodiment, a retaining member 16 includes a base portion 38 that is configured to slide into and be retained by grooves in the central clip retaining feature, and further includes a spring clip portion 40-1 and 40-2 that is configured to clip onto the central channel 20. In at least one such embodiment, the retaining member(s) 16 comprise plastic or other resilient spring clips which flexibly and removably clip or snap onto the central channel 20 of the base member 12.

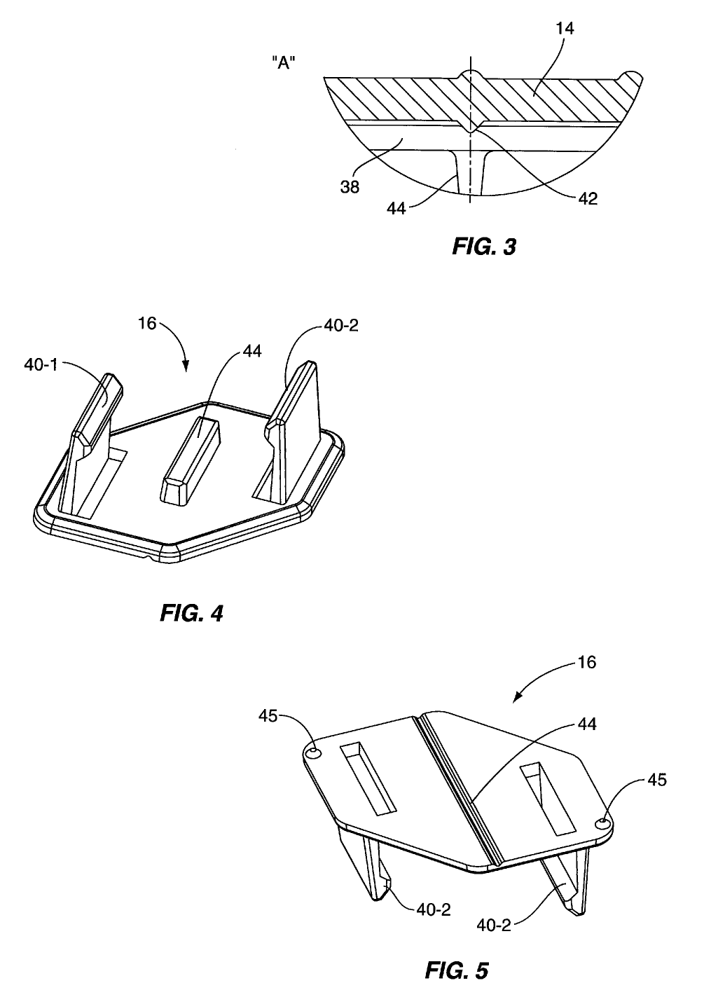

FIG. 3 provides more detail regarding one embodiment of the trim assembly 10 wherein the retaining members 16 slide into and are retained by the central clip retaining feature 18 of the cover member 14. More particularly, FIG. 3 depicts detail View A from FIG. 1, wherein one sees that the cover member 14 may include a projection 42 running along its centerline, which mates with a corresponding inset or recess in the base portion 38 of a retaining member 16. One also sees that the retaining member 16 may include a projection 44, which is explained below.

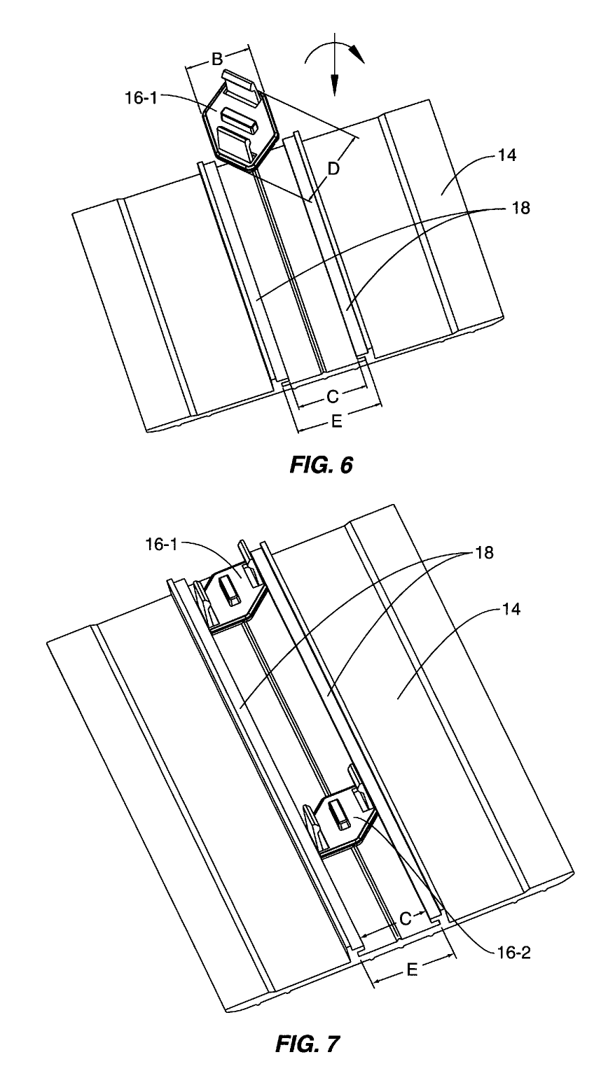

FIGS. 4 and 5 illustrate these features in more detail for the corresponding retaining member 16. FIG. 5 also illustrates that a topside surface of the retaining member 16 may include bumps or other projections 45 at its opposite corners, the purpose of which is explained below.

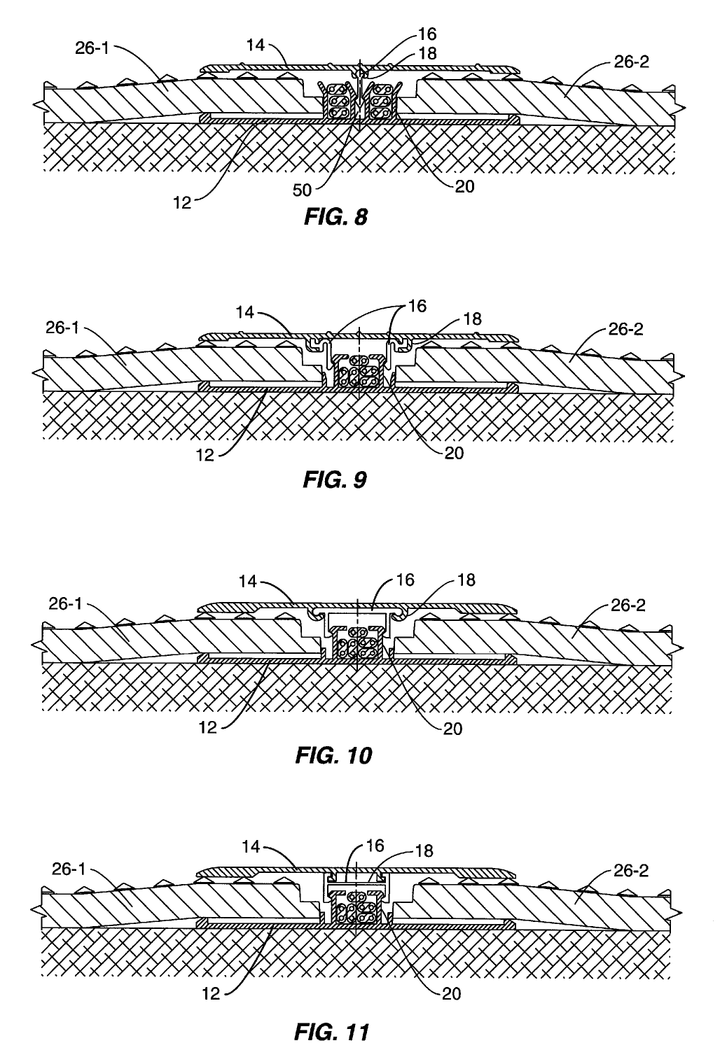

FIGS. 6 and 7 illustrate bottom-side views of a section of the cover member 14, and illustrate the installation of one or more retaining members 16 into the cover member 14. In the illustrated embodiment, the installer positions a retaining member 16 at the desired position along the length of the cover member 16, drops it into the slot or channel formed by the clip retaining feature 18, and rotates the retaining member 16 into engagement.

In more detail, FIG. 6 illustrates the insertion of a retaining member 16 into the central clip retaining feature 18. More particularly, the retaining member 16 is installed in a “working” position, where its narrow dimension “B” is less than the width of the interior channel of the central clip retaining feature 18. The retaining member 16 is rotated clockwise to engage with the central clip retaining feature 18. (The arrows in FIG. 6 illustrate the direction of installation movements). The projections 45 shown on the topside surface of the retaining member 16 illustrated in FIG. 5 provide a tight fit for the retaining member 16 as it is rotated into its engaged position, and thereby effectively “lock” the retaining member 16 in its rotated position. Such locking prevents the retaining member 16 from sliding back and forth within the track or channel formed by the central clip retaining feature 18, and prevent it from unlocking from its rotated position.

Thus, retaining members 16 are placed narrow-wise into the central clip retaining feature 18, and rotated into an engaged position, where they are retained within the clip retaining channel of the central clip retaining feature 18. The following dimensional dependencies are used in at least one such embodiment of the retaining member 16: B=C−2t, where B is the width of the retaining member 16 in specified direction; C is the width of the opening as illustrated for the central clip retaining feature 18; t is the gap needed to accumulate manufacturing tolerances; D=E−2t, where D is the width of the retaining member 16 in the specified direction; and E is the width of the clip retaining channel formed within the central clip retaining feature 18.

For further installation convenience, the projection 44 of the retaining member 16 may be gripped by pliers or other tool, to effect rotation, and the earlier illustrated projection 42 of the cover member 14 generally prevents the retaining members 16 from rotating back out of engagement. Similarly, one or more slots could be molded into the retaining member 16, so that screwdrivers or the like could be used to rotate it into the engaged position.

More generally, it should be understood that each retaining member 16 can be a long part, an extruded profile for example, or a short part, with “long” and “short” having at least relative meaning with respect to the length of the base and cover members 14 and 16. In at least one embodiment, the base and cover members 12 and 14 are extruded aluminum parts and the retaining members 16 are injection molded plastic parts, and the number of retaining members 16 used to secure base and cover members 12 and 14 together depends on the lengths of the base and cover members 12 and 14.

Returning to FIG. 2, the cover member 14 includes cover areas 46-1 and 46-2 on either side of the central clip retaining feature 18. These cover areas 46-1 and 46-2 overlie the topside edge regions of the adjacent safety mats being joined by the trim assembly 10. The edges of the cover member 14 also may include downward facing lands or pads 44, which facilitates positive contact between the cover member 14 and the topside surfaces of the adjacent safety mats joined by the trim assembly 10.

With the above embodiments as working examples, it will be appreciated that the trim assembly 10 more broadly comprises an apparatus for actively joining adjacent safety mats. In broad terms, the trim assembly 10 comprises an elongate base member 12, an elongate cover member 14, and one or more retaining members 16. The base member 12 comprises upwards facing base areas 30-1 and 30-2 on either side of a central channel 20 running along a length of the base member 12, each base area (30-1 or 30-2) configured to underlie an abutting edge region of a respective one of the adjacent safety mats. The cover member 14 comprises downwards facing cover areas 46-1 and 46-2 on either side of a central clip retaining feature 18 running along a length of the cover member 14, each cover area (46-1 or 46-2) configured to overlay the abutting edge region of a respective one of the adjacent safety mats.

With the above base and cover members 12 and 14, the retaining member(s) 16 are configured to flexibly clip the cover and base members together in a manner that allows the cover member 14 to float on the abutting edge regions of the adjacent safety mats, such that downward force on the cover member 14 transfers to one or both of the adjacent safety mats. Thus, in at least one embodiment, the retaining members 16 comprise one or more flexible clips engaged with the central clip retaining feature 18 of the cover member 14. These flexible clips, such as shown in FIGS. 1-4, are configured to snap onto the central channel 20 of the base member 12 and slide vertically downward along one or more walls of the central channel 20, thereby allowing the cover member 14 to float on the abutting edge regions of the adjacent safety mats. As noted, in such a configuration, the retaining members 16 may comprise an anchor portion that engages with the central clip retaining feature 18 of the cover member 14 and a spring clip portion that extends downward and is configured to releasably clip onto the central channel 20 of the base member 12.

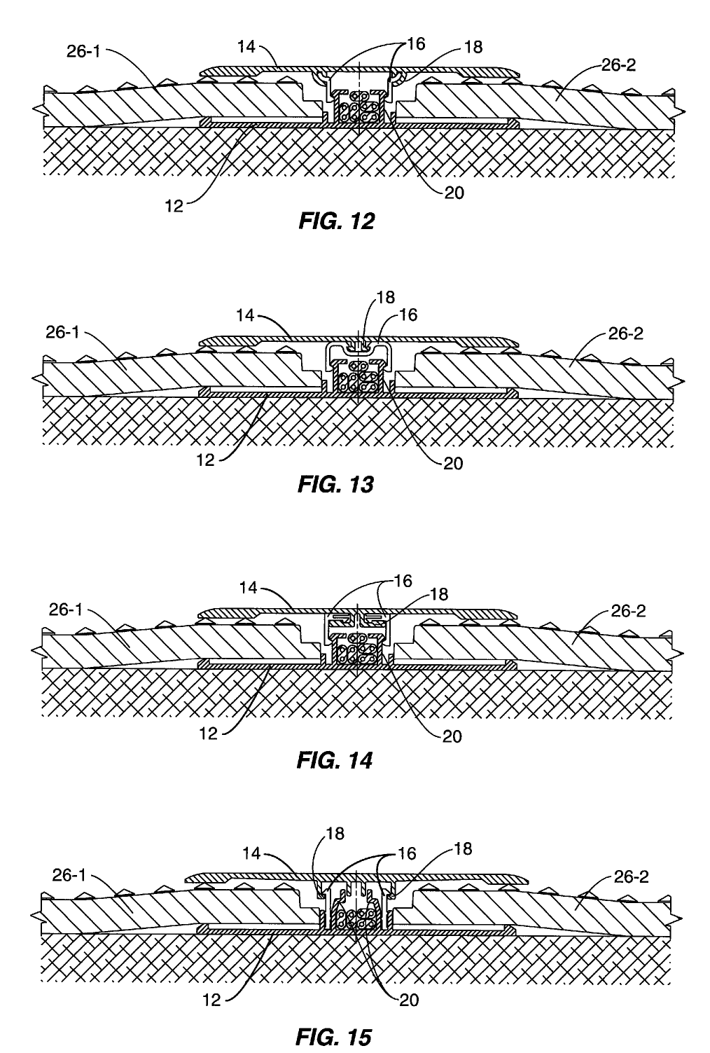

Several other embodiments of the retaining member 16 are also contemplated herein. For example, FIG. 8 depicts an embodiment of the trim assembly 10 wherein the central channel 20 of the base member 12 is divided into two sections by a central opening 50, which is configured to receive and retain a “plunger” like configuration of the retaining member 16. In such embodiments, the base or anchor portion of the retaining members 16 can be slid end-wise into a corresponding groove or channel in the central clip retaining feature 18 of the cover member 14.

FIGS. 9-15 illustrate various other embodiments of base and cover members 12 and 14, and corresponding embodiments of retaining members 16. Notably, one sees that the retaining members 16 can be formed as one-piece assemblies (FIG. 10, for example), and as two-piece assemblies (FIGS. 12 and 15, for example). Also, in FIG. 15, one sees that the base member 12 rather than the cover member 14 can be configured to hold the retaining members 16, for clipping onto the central clip retaining feature 18 of the cover member 14. In FIG. 12, the retaining members 16 may be implemented as long pieces, or as a number of spaced-apart short pieces, which are slid end-wise into corresponding grooves or channels formed within or alongside the central channel of the base member 12.

Thus, in at least some embodiments, retaining members 16 comprise a one or two-piece assembly that includes an anchor portion that engages with the central channel 20 of the base member 12 and a spring clip portion that extends upward and is configured to releasably clip onto the clip retaining feature 18 of the cover member 14. In other embodiments, retaining members 16 comprise an anchor portion that engages with the clip retaining feature 18 of the cover member 14 and a downwardly extending portion (spring clips, plunger, etc.) that is configured to releasably clip onto or into the central channel 20 of the base member 12.

Regardless of these embodiment details, the trim assembly 10 supports a method of actively joining adjacent safety mats comprising positioning a base member 12 lengthwise under abutting mat edges formed by adjacent safety mats 26-1 and 26-2, such that the base member 12 underlies a mat seam formed by the abutting mat edges, and positioning a cover member 14 lengthwise over the abutting mat edges and above the base member 12, such that the cover member 14 overlays the mat seam. With that positioning, pressing downward on the cover member 14 actuates one or more retaining members 16 positioned between the cover member 14 and base member 12 and thereby snaps or otherwise locks the base and cover members 12 and 14 together. Because the retaining members 16 comprise one or more flexible clips configured to clip the cover member 14 into sliding vertical engagement with the base member 12, the cover member 14 floats on the on topside surface of the abutting mat edges and functions as an active weight sensing element.

The trim assembly 10 also comprises one part of a safety mat system that includes first and second safety mats to be adjacently positioned and joined by the trim assembly 10. Any one of the foregoing embodiments of trim assembly 10 may be included in the safety mat system. Of course, the safety mats and trim assemblies 10 may be sold and packaged separately, and assembled at the jobsite. Thus, the present invention contemplates trim assemblies 10 as well as complete safety mat systems, along with corresponding methods of assembly.

With the above range of variations in mind, it should be understood that the present invention is not limited by the foregoing description, nor is it limited by the accompanying drawings. Instead, the present invention is limited only by the following claims, and their legal equivalents.

What is claimed is:

1. A joining trim assembly for actively joining adjacent safety mats, said joining trim assembly comprising:
a base member configured to underlie a mat seam formed by abutting mat edges of adjacent safety mats;
a cover member configured to overlay the mat seam; and
one or more retaining members configured to couple the cover and base members together, while allowing the cover member to float on the abutting mat edges and thereby transfer a downward force applied to the cover member to one or both of the adjacent safety mats.

2. The active joining trim assembly of claim 1, wherein the one or more retaining members comprise one or more flexible clips that clip the cover member and the base member together in vertically sliding engagement, thereby allowing the cover member to float on the abutting mat edges.

3. The active joining trim assembly of claim 1, wherein the one or more flexible clips are formed from a resilient material that allows the cover member, when clipped to the base member, to tilt from side to side in response to off-center downward force being applied to a topside of the cover member.

4. The active joining trim of claim 1, wherein the base member includes a central channel that projects vertically upward, and wherein the one or more retaining members comprise one or more flexible clips configured to engage an underside of the cover member and removably clip the cover member to the central channel.

5. The active joining trim of claim 4, wherein the one or more flexible clips are configured to slide along one or more vertical walls of the central channel, thereby allowing the cover member to float on the abutting mat edges.

6. The active joining trim of claim 1, wherein the base member includes a central channel that projects vertically upward, and wherein the one or more retaining members comprise one or more flexible clips configured to engage the base member and removably clip to an underside of the cover member.

7. The active joining trim of claim 6, wherein the cover member is configured to slide vertically downward on the one or more flexible clips, thereby allowing the cover member to float on the abutting mat edges.

8. The active joining trim of claim 1, wherein the base member includes a central channel configured to project vertically upward into the mat seam, and wherein the central channel comprises a cable raceway for routing safety mat cables.

9. A method of actively joining adjacent safety mats comprising:
positioning a base member lengthwise under abutting mat edges formed by adjacent safety mats, such that the base member underlies a mat seam formed by the abutting mat edges;
positioning a cover member lengthwise over the abutting mat edges and above the base member, such that the cover member overlays the mat seam;
pressing downward on the cover member to actuate one or more retaining members positioned between the cover and base members and thereby snap the cover and base members together;
said one or more retaining members comprising one or more flexible clips configured to clip the cover member into sliding vertical engagement with the base member, thereby allowing the cover member to float on the abutting mat edges.

10. An apparatus for actively joining adjacent safety mats, the apparatus comprising:
an elongate base member comprising upwards facing base areas on either side of a central channel running along a length of the base member, each said base area configured to underlie an abutting edge region of a respective one of the adjacent safety mats;
an elongate cover member comprising downwards facing cover areas on either side of a central clip retaining feature running along a length of the cover member, each said cover area configured to overlay the abutting edge region of a respective one of the adjacent safety mats; and
one or more retaining members configured to flexibly clip the cover and base members together in a manner that allows the cover member to float on the abutting edge regions of the adjacent safety mats, such that downward force on the cover member transfers to one or both of the adjacent safety mats.

11. The apparatus of claim 10, wherein the one or more retaining members comprise one or more flexible clips engaged with the central clip retaining feature of the cover member, said one or more flexible clips configured to snap onto the central channel of the base member and slide vertically downward along one or more walls of the central channel, thereby allowing the cover member to float on the abutting edge regions of the adjacent safety mats.

12. The apparatus of claim 10, wherein the one or more retaining members comprise one or more flexible clips engaged with the central channel of the base member, said one or more flexible clips configured to snap onto the clip retaining feature of the cover member and allow the clip retaining feature to slide vertically downward on the one or more flexible clips, thereby allowing the cover member to float on the abutting edge regions of the adjacent safety mats.

13. The apparatus of claim 10, wherein the cover and base members comprise extruded aluminum pieces formed or cut to a desired length, and wherein the one or more retaining members comprise one or more flexible plastic clips.

14. The apparatus of claim 10, wherein the one or more retaining members comprise an anchor portion that engages with the clip retaining feature of the cover member and a spring clip portion that extends downward and is configured to releasably clip onto the central channel of the base member.

15. The apparatus of claim 10, wherein the one or more retaining members comprise a one or two-piece assembly that includes an anchor portion that engages with the central channel of the base member and a spring clip portion that extends upward and is configured to releasably clip onto the clip retaining feature of the cover member.

16. The apparatus of claim 10, wherein the central channel of the base member includes a cable raceway for routing safety mat cables.

17. A safety mat system comprising:
first and second safety mats adjacently positioned; and
an apparatus for actively joining the first and second safety mats;
said apparatus comprising an active joining trim assembly including:
an elongate base member comprising upwards facing base areas on either side of a central channel running along a length of the base member, each said base area configured to underlie an abutting edge region of a respective one of the adjacent first and second safety mats;
an elongate cover member comprising downwards facing cover areas on either side of a central clip retaining feature running along a length of the cover member, each said cover area configured to overlay the abutting edge region of a respective one of the adjacent first and second safety mats; and
one or more retaining members configured to flexibly clip the cover and base members together in a manner that allows the cover member to float on the abutting edge regions of the adjacent first and second safety mats, such that downward force on the cover member transfers to one or both of the adjacent safety mats.
